(19) United States
(12) Patent Application Publication
(10) Pub. No.: US 2010/0217877 A1
(43) Pub. Date: Aug. 26, 2010

(54) Method and System for Enabling Access Policy and Charging Control

(75) Inventors: Per Willars, Vaxholm (SE); Henrik Albertsson, Stockholm (SE); Victor Manuel Avila Gonzalez, Madrid (ES); Ana Maria Lopez Nieto, Madrid (ES); Belen Pancorbo Marcos, Madrid (ES); Jose Javier Pastor Balbas, Madrid (ES); Guadalupe Sanchez Santiso, Madrid (ES)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSSON (PUBL), Stockholm (SE)

(21) Appl. No.: 12/682,392

(22) PCT Filed: Oct. 16, 2007
(86) PCT No.: PCT/SE2007/000909

§ 371 Date: Apr. 9, 2010

(51) Int. Cl. G06F 15/16

(52) U.S. Cl. 709/228; 709/231; 709/245; 709/227

(57) ABSTRACT

The present invention relates in general to a method and apparatus concerning access policy and charging control. In particular it relates to enhanced service information for access policy and charging control. A media stream management of a service session between a first and a second electronic communication device comprise obtaining identity address data related to the first electronic communication device step, obtaining policy information associated with the second electronic communication device step, and performing a media stream management control step involving the identity address data related to the first electronic communication device and the policy information related to the second electronic communication device such that media streams between the first electronic communication device and the second electronic communication device can be controlled.

### TECHNICAL FIELD

The present invention relates in general to a method and apparatus concerning access policy and charging control. In particular it relates to enhanced service information for access policy and charging control.

### BACKGROUND

The Policy and Charging Control (PCC) architecture permits to integrate both policy and charging control, thereby optimising information flows.

An architecture that supports the PCC functionality is depicted in FIG. 1.

Within this figure, the Application Function (AF) 104 is an element offering applications in which service is delivered in the transport layer, whereas the service is requested in the signalling layer.

One example of an AF is the Proxy—Call Session Control Function (P-CSCF) of the Internet Protocol (IP) Multimedia Core Network (IM CN) subsystem. The AF communicates with the Policy and Charging Rules Function (PCRF) 108 to transfer dynamic session information, that is description of the media to be delivered in the transport layer. This communication is performed using the Rx interface 106. The information in the Rx interface is derived from the session information in the P-CSCF and it mainly includes what is called media components. A media component is composed by a set of IP flows, each one described through a 5-tuple, the media type and bandwidth required.

The session information is Session Description Protocol (SDP) in the case Session Initiation Protocol (SIP) is used for signalling. However, as an alternative the Real Time Streaming Protocol (RTSP) may be also used.

The PCRF is the function that provides policy and charging control for the media components negotiated between the UE 102 and the AF 104. For that purpose, the PCRF creates PCC rules based on the information received from the Rx interface. The PCRF, depending on the user and the requested service, includes charging and policy information along with a set of IP filter information: each IP 5-tuple is composed of source and destination IP address and ports, and the protocol identity above IP, that is Transmission Control Protocol (TCP) or User Datagram Protocol (UDP). The filters included in PCC rules define what is called Service Data Flows (SDF), that is data flows that are treated in the same way regarding policy and charging. These Service Data Flows are installed in PCEF 110 through the Gx interface.

The PCEF 110 encompasses service data flow detection, based on the filters definitions included in the PCC rules, as well as online and offline charging interactions and policy enforcement. The PCEF 110 is where the Quality of Service (QoS) is being enforced for the bearer according to the QoS information coming from the PCRF 108. This functional entity is located at the Gateway (for example General Packet Radio Service (GPRS) Gateway Support Node (GGSN) in the GPRS case, and Packet Data Gateway (PDG) in the Wireless Local Area network (WLAN) case).

Typically, the QoS is set based on SIP/SDP attributes, and also a standardised IP Multimedia Subsystem (IMS) Communication Service Identifiers, ICSI.

It is a drawback that the QoS cannot be set more freely and be customized for each occasion.

One problem is however that IARI is vulnerable to fraud, i.e. any other application or service provider may actually hijack an IARI that is for instance entitled to premium QoS.

There is therefore a need for a system and method, which enable provision of QoS in a reliable and customizable way.

### SUMMARY

An object of the present invention is to provide methods for providing an improved call service, as well as to provide an application node, a policy node and a system for providing an improved call service.

According to a first aspect, there is provided a method for providing management control attribute data for media stream management control of a service session between a first electronic communication device and a second electronic communication device, said method comprising the steps receiving a service session related request, obtaining identity address data related to the first electronic communication device, and sending an attribute related policy request message associated with the service session request to a policy decision node, said message comprising the obtained identity address data related to the first electronic communication device, such that the message can be processed by the policy decision node.

The method may further comprise receiving an attribute related policy response message associated with the requested service session, from the policy decision node.

The step of obtaining identity address data within the method may further comprise obtaining identity address data related to the second electronic communication device, and the attribute related policy request message may further comprise the obtained identity address data related to the second electronic communication device.

The step of obtaining identity address data within the method may further comprise obtaining public service identity address data.

According to a second aspect, there is provided an application node for providing management control attribute data for media stream management control of a service session between a first electronic communication device and a second electronic communication device, said application node comprising a receiving unit adapted to receive a service session related request, a processing unit adapted to obtain identity address data related to the first electronic communication device, and a transceiving unit adapted to send an attribute related policy request message associated with the service session request.

The transceiving unit of the application node may further be adapted to receive an attribute related policy response message associated with the requested service session.

According to a third aspect, there is provided a method for processing of management control attribute data for media stream management control of a service session between a first electronic communication device and a second electronic communication device, said method comprising the steps of receiving an attribute related policy request message associated with the service session request, from an application node, said message comprising identity address data related to the first electronic communication device, obtaining policy information associated with the second electronic communication device, and performing a media stream management control involving the identity address data related to the first electronic communication device and the policy information related to the second electronic communication device.

The method for processing of management control attribute data may further comprise the step of sending an attribute related policy response message associated with the requested service session, to the application node, to enable provision of the requested service session between the first and second electronic communication devices, in dependence of the performed media stream management control.

The step of receiving the attribute related policy request message within the method for processing of management control attribute data, may further comprise receiving an attribute related policy request message comprising identity address data related to the second electronic communication device, and the step of performing the media stream management control may further comprise performing said media stream management control involving the identity address data related to the second electronic communication device.

The service session between the first electronic communication device within the method for processing of management control attribute data may be set up from the first electronic communication device to the second electronic communication device.

The service session between the first electronic communication device within the method for processing of management control attribute data may be set up from the second electronic communication device to the first electronic communication device.

The step of performing a media stream management control within the method for processing of management control attribute data may comprise performing a control of the quality of service class for a flow of packets of the media stream.

The step of performing a media stream management control within the method for processing of management control attribute data may comprise performing a control of charging parameters for a flow of packets of the media stream.

According to a fourth aspect, there is provided a policy decision node adapted to process management control attribute data for media stream management control of a service session between a first and a second electronic communication device, said policy node comprising a transceiving unit adapted to receive an attribute related policy request message associated with a service session request, said policy request message comprising identity address data related to the first electronic communication device, a storing unit adapted to obtain policy information associated with the second electronic communication device, and a comparing unit adapted to perform a media stream management control involving the identity address data related to the first electronic communication device and the policy information associated with the second electronic communication device.

The transceiving unit of the policy decision node may further be adapted to send an attribute related policy response message associated with the requested service to enable provision of the service session between the first and second electronic communication devices, in dependence of the performed media stream management control.

According to a fifth aspect, there is provided a method for media stream management of a service session between a first electronic communication device and a second electronic communication device, said method comprising obtaining identity address data related to the first electronic communication device, obtaining policy information associated with the second electronic communication device, and performing a media stream management control involving the identity address data related to the first electronic communication device and the policy information related to the second electronic communication device such that media streams between the first electronic communication device and the second electronic communication device can be controlled.

According to a sixth aspect, there is provided a system for performing media stream management of a session between a first electronic communication device and a second electronic communication device, said system comprising a processing unit adapted to obtain identity address data related to the first electronic communication device, a storing unit adapted to obtain policy information associated with the second electronic communication device, and a comparing unit adapted to perform the media stream management control involving the identity address data related to the first electronic communication device and the policy information associated with the second electronic communication device, enabling media stream management control of session between the first electronic communication device and the second electronic communication device.

It should be emphasized that the term “comprises/comprising” when being used in the specification is taken to specify the presence of the stated features, integers, steps or components but does not preclude the presence or addition of one or more other features, integers, steps or components or groups thereof.

### BRIEF DESCRIPTION OF THE DRAWINGS

In order to explain the invention and the advantages and features thereof in more detail, embodiments of the invention will be described below, references being made to the accompanying drawings, in which

FIG. 1 is a block diagram illustrating PCC architecture of prior art;

FIGS. 2, 8, and 11-14 are block diagrams illustrating embodiments of signal exchange;

FIGS. 3 and 4 block diagrams illustrating embodiments of architectures;

FIG. 5 presents a table illustrating an embodiment of QoS determination;

FIGS. 6 and 7 are block diagrams illustrating embodiments of an application node and a policy node, respectively, and

FIGS. 9 and 10 are flow-charts illustrating embodiments of method steps.

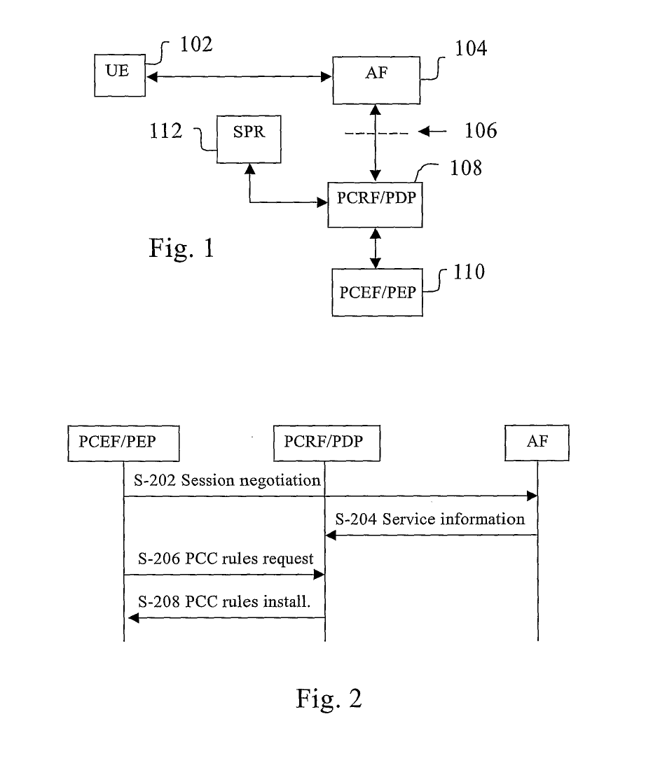

### DETAILED DESCRIPTION

As was described earlier, the QoS is typically set based on SIP/SDP attributes, and also a standardised IMS Communication Service Identifiers, ICSI.

This does however not allow differentiation for a specific service provider.

As was mentioned above the QoS may be set based on SIP/SDP attributes, and also a standardised IP Multimedia Subsystem (IMS) Communication Service Identifiers, ICSI. In addition to this, it may be possible for the operator to look at the IMS Application Reference Identifier, IARI, and assuming the SP has provided the operator with an IARI value, the differentiation could be done on basis of this.

If the operator looks at the IMS Application Reference Identifier, IARI, and assumes that the Service provider (SP) has provided the operator with an IARI value, this would enable differentiation based on the IARI value. However, the problem is however that IARI is vulnerable to fraud, that is any other application or service provider may in reality hijack an IARI that is, for instance, entitled to premium QoS.

Mechanisms for providing QoS aspects to future Multi Media services are with preference flexible in order to serve the market requirements; mechanisms available today lack the possibility to tie the QoS to a specific service provider.

According to prior art techniques, the PCRF may determine the charging and QoS policy based on a subset of SDP parameters, such as the media type. In addition the PCRF may determine said charging and QoS policy in dependence the requested service as revealed by service identifiers such as the ICSI that are passed through the Rx interface.

Where the service identification would allow differentiation for a specific service provider or to identify different contents in a streaming server that are identified by different Uniform Resource Identifiers (URIs) in the Real Time Streaming Protocol (RTSP), using the IARI as received on the Rx interface would not be sufficient.

It is currently not clear to the applicant how to apply different policies to allow differentiation, for example in QoS, for a service that is offered by different service providers.

In addition, it is not obvious to the applicant how to apply different policies per service provider in the case the PCC architecture is used for policy control.

One example of the services that require a deeper differentiation is a streaming service in which it is required to differentiate the traffic that corresponds to the access to a movie or to a football match.

Thus, in the existing solutions the information only permits to classify the traffic in different services based on the parameters currently signalled on the Rx.

The invention proposes the enhancement of the information that is transferred from AF to PCRF in order to permit a better identification of the services in order to perform traffic policing.

The invention affects the PCRF wherein Service session and media component information (service data flow information) analysis will be performed with enhanced service information.

The invention also affects the AF, wherefrom Enhanced Service session information and media component information (service data flow information) is forwarded.

Moreover, the invention makes an impact on the Rx interface. The updated service information may contain new information that permits performing a deeper service identification and policy control.

The Rx information is enhanced, using the request-Uniform Resource Identifier (URI) or request-Uniform Resource Locator (URL) to differentiate QoS handling, such that IP Multimedia Subsystem (IMS) calls going to the specific Service Provider (SP) are differentiated.

This is not vulnerable to fraud, since the call has to be addressed to the desired SP in any case.

If the QoS policy would be enforced based on the raw request-URI sent from the client, that is before any originating destination address analysis has been done, a problem of matching the sent request-URI with the addresses as provisioned, could occur, due to the request-URI and the addresses as provisioned being in different formats. This problem is alleviated by letting the Service Provider (SP) coordinate these formats, so that the format of the request-URI sent from the client is identical to the one the operator has provisioned in its policy system.

The SP ensures that the URI of the links on its server are matching exactly the request-URI provided to the operator.

Alternatively, the SP provides the application software to the terminal, and ensures that this SW uses exactly the same request-URI.

According to the prior art, the information only permits to classify the traffic in different services based on the SDP information such as media type, and optionally ICSI and IARI. There is hence a need to extend this information in order to permit a deeper analysis of traffic for the purpose of service data flow classification and subsequent policy and charging control enforcement.

For example, the IP header inspection is not enough for services that are hidden behind a proxy and a more detailed inspection of the payload traffic is desirable in order to differentiate the service data flows. This would allow to apply service authorization and correct charging, gating and QoS control based on the actual contents that the user is accessing, using a content-based service control, as well as the specific event, that is the specific access to the service. In addition, there is a need to differentiate the access to a specific service provider.

When a bearer, for instance a PDP context, is established and initiated from the terminal, the PCEF informs the PCRF that a new bearer has been established. Then the PCRF provides PCC rules to the PCEF with the policies to be enforced. These PCC rules are determined by PCRF based on information that is received from the AF (determined during the session set up negotiation between the end points) combined with predefined information defined by the operator in PCRF and bearer and network information received from PCEF. Another possibility is that the PCRF initiates itself PCC rule download, triggered by an AF session activation/modification, which in turn triggers the setup or the modification, as an alternative, of the PDP context.

According to some embodiments, the Long-term Evolution/System Architecture Evolution (LTE/SAE) is used, as an alternative to GSM/WCDMA. Here, the bearer is denoted Evolved Packet System (EPS) bearer.

Each PCC rule includes a Service Data Flow and policy and charging data. These data allows the PCEF to perform traffic classification and policy enforcement and charging.

The AF will send the enhanced service information to the PCRF, which will analyse this information and compose the PCC rules that apply for the service. This PCC rules contain information to identify the service.

The PCEF will then perform packet inspection in order to classify traffic according to the information received from PCRF. The PCEF analyses the IP packets in a bearer using the installed PCC rules. The analysis is performed using the stored service data flows filters that will be used to identify the service data flow.

Below and as illustrated in FIG. 2 a high-level use case is described wherein the above-mentioned functionality is applied for terminal-initiated bearer setup.

First, the UE and the AF negotiates service session parameters using application level signalling, typically the UE negotiates the type of media and detailed parameters such as codec or rates, signal S-202.

Thereafter, the AF informs the PCRF about the negotiated media components, S-204. The existing Rx message needs to be updated to include enhanced service information that defines the media information. As was mentioned above the Rx message is extended to include the request URI or URL to access to the service.

The PCRF then creates the PCC rules according the information received from the AF and calculates the charging and policy data that applies to such PCC rules using this information.

The PCEF subsequently requests PCC rules to be installed on the established bearer for the service the user is accessing, S-206.

The PCRF finally downloads the PCC rules to apply for the bearer, S-208.

As mentioned above, the bearer setup as illustrated in FIG. 2 is terminal-initiated. In the case the bearer setup is network initiated, the step S-206 is preceded by step S-208. Step S-208 would then comprise the provision of PCC rules to apply, whereas step S-206 would comprise an answer indicating that resources were established.

### Architecture

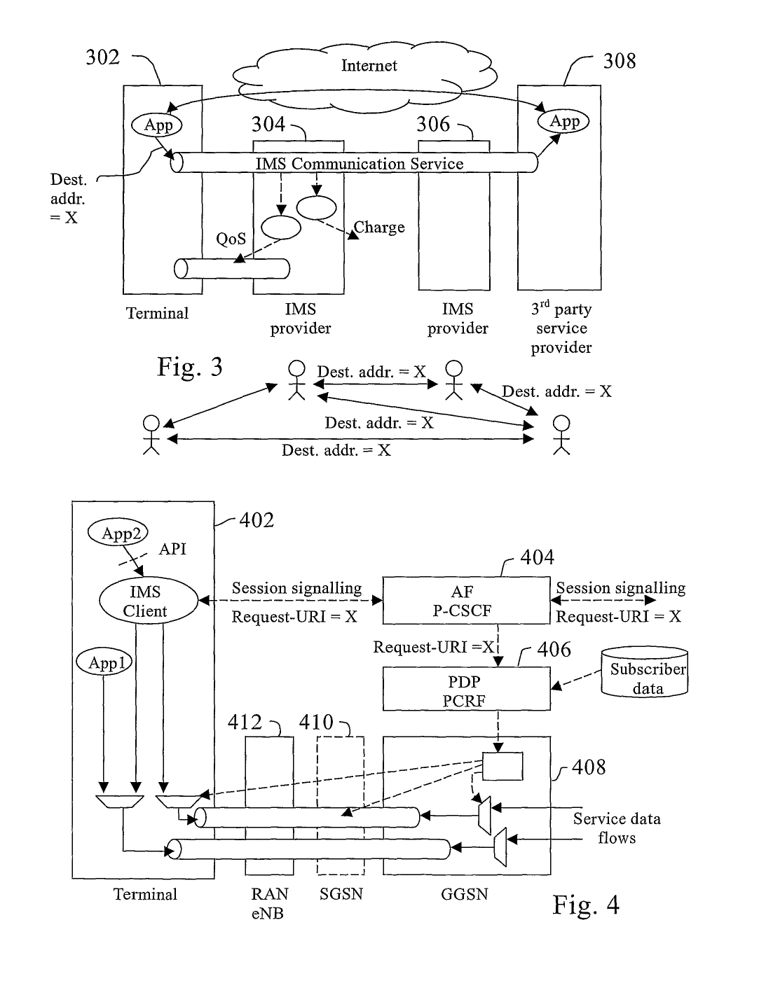

In FIG. 3 the overall architecture and the pertaining business relations are shown.

The end-user of the terminal 302 accesses a service from the service provider 308, partly via the Internet, and partly by using IMS communication services. The IMS operators 304, 306 have interconnect agreements. The service provider 308 has a business relation with the terminating IMS operator 306. The service provider 308 may also have a relation to the originating IMS operator 304. Thus, the destination address, as in FIG. 3 is written as “X”, may reach the originating IMS operator 304 directly from the service provider 308, or via the other IMS operator(s) 306.

Based on the Uniform Resource Identifier (URI) address, the originating IMS operator 304 decides a special QoS for the IMS session. In addition, the charging may also be differentiated on the destination address, as shown in FIG. 3.

FIG. 4 presents an architecture where a 3GPP network with the new feature of network-initiated QoS, is controlled by the PCRF to provide a certain QoS class to a given flow.

As shown this architecture comprises a terminal 402, from which session signalling may be performed to the AF or the Proxy—Call session Control Function (P-CSCF) 404. This signalling preferably comprises a request-Uniform Resource Identifier (URI), according to the SDP/SIP. Within this example the address is thus the request-URI that in this example equals “X”. The AF/P-CSCF then forwards the address data to the PCRF/Policy decision Point (PDP) 406 that may have access to subscriber data, possibly from the Subscription Profile repository (SPR), not shown in FIG. 4. The PCRF accordingly decides a relevant QoS and charging and installs PCC rules into the PCEF, which is this example, corresponds to the Gateway GPRS Support Node (GGSN). For this example it should be mentioned that the PCRF has decided to offer two different QoS classes dependent on the request-URI and possibly also in dependence of the identity of the applications requested. Each application may be identified by an IMS Application Resource Identifier (IARI) identifier, which identifier may be used to differentiate the QoS class to be granted to the requested service.

As shown in FIG. 4, two QoS classes are thus illustrated by the bearer or PDP context tubes between the GGSN 408 to the terminal 402. These PDP contexts pass via the Serving GPRS Support Node (SGSN) 410 and the Radio Access Network (RAN).

In the case of Long-Term Evolution (LTE), the RAN comprises enhanced Node Bs 412, where the bearer establishment passes via a MME (Mobility Management Entity) and the GW node.

Typically, one bearer is the default bearer with a best effort QoS class, and the other is a dedicated bearer dynamically setup to match the QoS requirements of a particular media component.

It should be mentioned that the session signalling does not terminate at the AF/P-CSCF 404, but is forwarded as illustrated in FIG. 4. In addition, the GGSN acts as a gateway for the service data flows from a different network.

### Service Provider Differentiation

### Deployment of Service

The Service provider develops and deploys the service, typically with no relation to the IMS operator of the end user. This involves setting up a server, for instance a game server. It may include providing special client software for terminal handsets, which may be deployed via the handset vendor, or may be provided for user-initiated download. Alternatively, the terminal-side of the service may be designed to execute in a standard browser of the terminal.

In this example, the service includes setting up of an IMS session from the terminal to the server, for the purpose of carrying one or more data flows. The service provider controls that the IMS client in the terminal sets up the IMS session with a destination address that addresses one of its servers. This may be done by configuration of the software in the terminal, or by including the destination address links, which when accessed, will trigger the browser or another application in the terminal to set up an IMS call to the address. It is also possible that a client application in the terminal, provided by the SP, dynamically fetches the relevant URIs from the SP, and uses these to setup the IMS call.

Business Agreement with IMS Operator, Provisioning in Operators Network

Before doing the business agreement with the operator, the service may be executed, but the QoS will be the default level for that IMS communication service. If the service provider prefers a special treatment of the data flows for its particular service, it will make a business agreement with the IMS operator, to differentiate its traffic separately. This agreement includes provision of one or more destination addresses (SIP-URI or TEL-URL) to the operator.

According to an alternative embodiment, the service provider has a business relation only to another operator. The destination addresses to receive differentiated treatment are then made known to the IMS operator by agreements with the other operator. This may be performed directly or via a transit operator.

The operator provisions the destination addresses in the policy rules controlling the PCRF, such that any session set up towards these addresses, will be mapped to a QoS class with higher availability and retain ability characteristics. Optionally, the maximum bitrates provided can also be higher.

According to an alternative embodiment, the agreement with the service provider may state that only certain types of communication using these addresses, where a certain communication service is differentiated with respect to the very media type used, are subject to this upgrade of QoS.

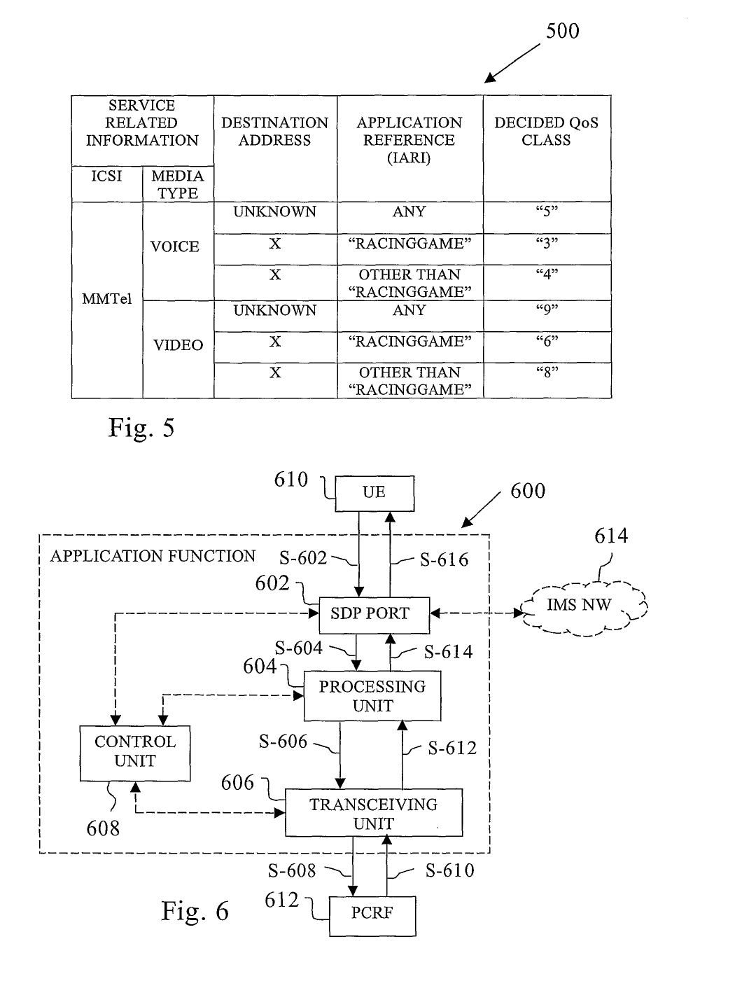

FIG. 5 shows one example of a table presenting parts of the policy rules in the PCRF, after this provisioning of QoS. The service related information within this example comprises ICSI as Multimedia Telephony (MMTel), whereas the media type may be either voice or video. In the case of unknown destination addresses, the IARI does not affect the QoS class that is decided. Any application will be given a QoS class “5” for voice, and a QoS class “9” for video type of media.

In case the destination address is known, here “X”, a different QoS class will be given to the application. In this example and as shown in this table, table 5, the QoS class is dependent on the IMS Application Reference Identifier (IARI), for which reason the “racing game” application will be given a different QoS class than other applications. This applies both to the voice and the video media type.

The IARI may thus also be taken into account along with the destination address to determine the QoS class.

### Policy Enabling Using Public Service Identifiers

By making use of public service identifiers (PSIs), such as SIP URI or TEL URL, policies may be differentiated and hence applied specifically. In the following paragraphs it will be described embodiments of an application node and a policy node as well as method steps for enabling differentiation of QoS, and optionally also charging, based on the PSI.

With reference to FIG. 6, an embodiment of an application node is presented in the form of an application function 600. The application function according to this embodiment comprises an SDP port 602, an processing unit 604 and a transceiving unit 606, where each one of these are controlled by a control unit 608. The application function may communicate with a UE 610 and be connected with a PCRF 612. Moreover, the SDP port 602 may be connected to the IMS network 614 for communication with remote parties.

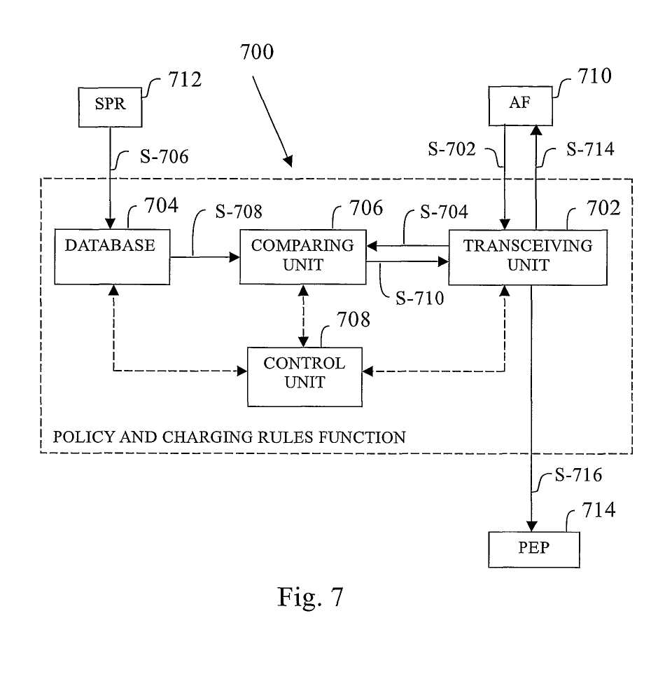

FIG. 7 illustrates an embodiment of a policy decision node, such as a Policy Decision Point (PDP) in the form of a Policy and Charging Rules Function (PCRF) 700, said PCRF comprising a transceiving unit 702, a database 704 and a comparing unit 706, all under control of a control unit 708. The transceiving unit 702 is according to his example connected to an AF 710. The database 704 may be connected to a Subscription Profile Repository (SPR) 712, and the transceiving unit 702 may communicate with Policy Enforcement Point (PEP) such as a Policy and Charging Enforcement Function (PCEF) 714.

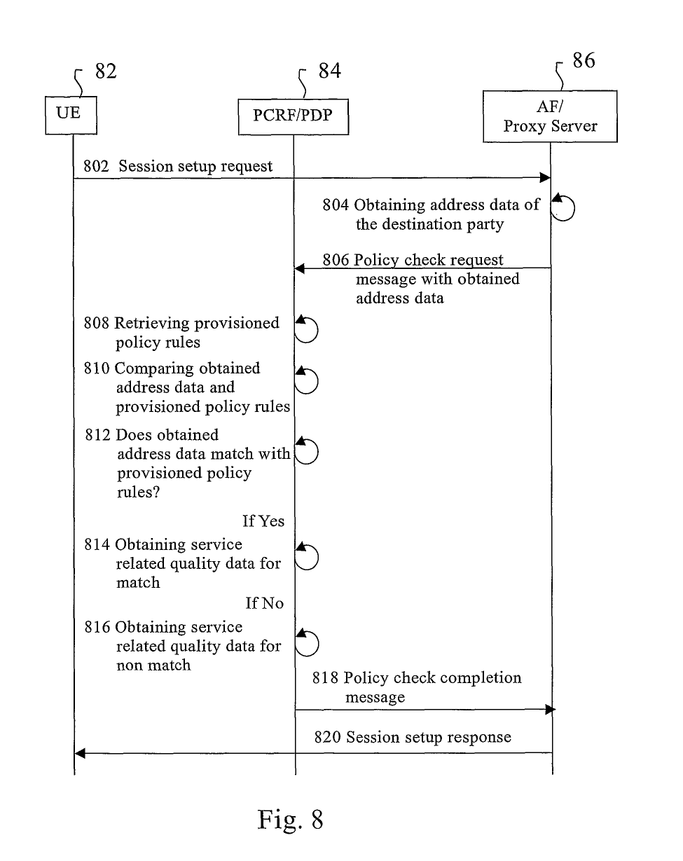

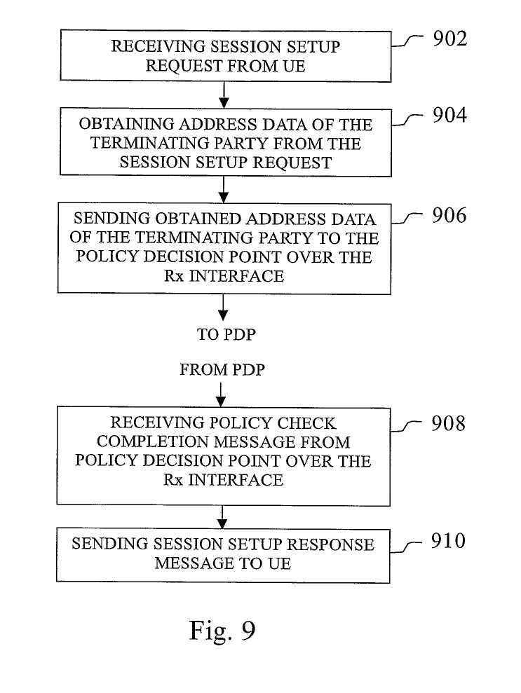

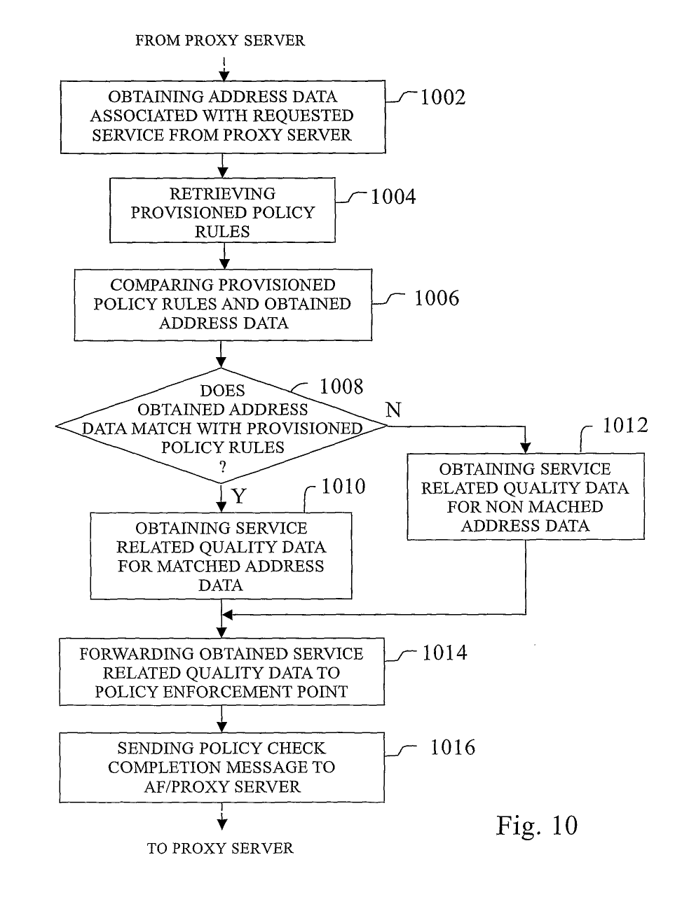

The function of the AF 600 and the PCRF 700 will now be explained in connection with presenting FIG. 8 illustrating an embodiment of signal exchange and FIGS. 9 and 10 illustrating embodiments of method steps.

The example of FIG. 8 comprises an example in which a user of a UE 82 requests a session to a destination address, for instance “Y”, by sending a session setup response to a proxy server 86 in setup 802.

The corresponding step in FIG. 9, illustrating method steps in an AF/proxy server function according to one embodiment, is represented by step 902, receiving a session setup request from the UE. This step is thus an example of the step of receiving a service session related request.

The session setup request as communicated in steps 802 and 902 is also illustrated with signal S-602 in FIG. 6, in which it is shown that the communicated information may be sent by the UE 610 and may be received by the SDP port 602 of the application function 600.

The SDP port 602 is typically adapted to receive a service session related request.

The information of the session setup request S-602 can then be forwarded in signal S-604 from the SDP port 602 to the processing unit 604 that is adapted to obtain identity address data related to a first electronic communication device, being the destination address in this example.

The proxy server or application function 600, 86 then obtains the address data of the destination party, according to this example, by letting the processing unit 604 extract the address data of the information sent in signal S-604, under the control of the control unit 608. This step corresponds to step 904, obtaining address data of the terminating party from the session setup request.

Step 904 is an example of the step of obtaining identity address data related to the first electronic communication device.

Having extracted the address data, said data is forwarded from the processing unit 604 to the transceiving unit 606 of the application function 600.

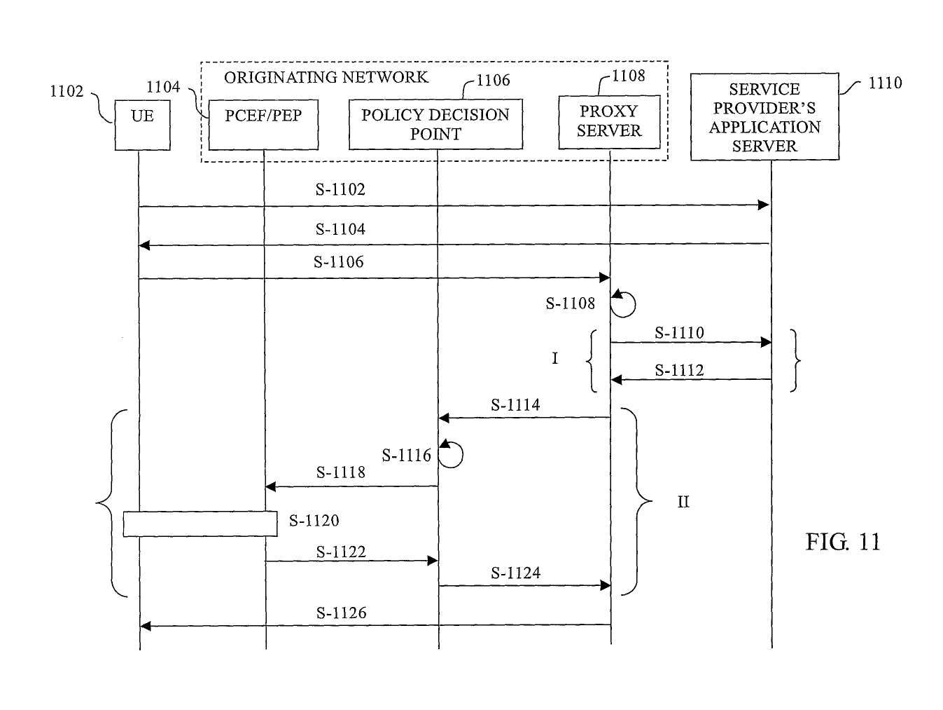

According to some embodiments, the application function or proxy-server 600 forwards the session setup request to the IMS network 614, and awaits a session setup response message from the IMS network before proceeding. A corresponding setup signalling is illustrated in FIG. 11.

The proxy server or application function 86 then sends a policy check request message with obtained address data to the PCRF/PDP 84, as depicted in step 806 of FIG. 8, by sending the address data of the destination party to the policy decision point over the Rx interface, as presented in step 906 of FIG. 9. In FIG. 6 this is also illustrated by signal S-608 from the transceiving unit of the application function 600 to the PCRF 612.

It can be pointed out that it is the transceiving unit 606 of the proxy server or application function 600, 86 which sends the policy check request message, being adapted to send an attribute related policy request message associated with the service session request.

Steps 806 and 906 are hence examples of sending an attribute related policy request message associated with the service session request to a policy decision node.

The address data has thus been extracted by the application function and forwarded to the PCRF to enable differentiation of the QoS based on the address data.

The transceiving unit 702 of the PCRF 700 of FIG. 7 accordingly receives the policy check request message from the AF 710, as illustrated by signal S-702 in FIG. 7. In FIG. 8 this corresponds to step 806, as earlier described.

The transceiving unit 702 is adapted to receive an attribute related policy request message associated with a service session request, said policy request message comprising identity address data related to the first electronic communication device here being represented by the destination address. One example of the first electronic communication device may be a communication server.

Referring to FIG. 10, illustrating method steps of the PCRF according to one embodiment, the receipt of address data is shown in step 1002, obtaining address data associated with requested service from the proxy server or application function.

The step 1002 is hence an example of the step of receiving an attribute related policy request message associated with the service session request, wherein the message comprises identity address data related to a first electronic communication device here being represented by the destination address.

Policy rules may be provisioned to a database 704 of the PCRF 700, where the database is one example of a storing unit being adapted to obtain policy information associated with a second electronic communication device, here being the UE 82.

From the Subscription Profile Repository (SPR) 712 subscriber specific policy data may optionally be forwarded to the database 704 of the PCRF 700. The PCRF may then retrieve the provisioned policy rules as illustrated in steps 808 and 1004, in sending information in signal S-708 to the comparing unit 706.

Retrieving the policy rules in steps 808 and 1004 is thus an example of obtaining policy information associated with the second electronic communication device, here being a mobile phone or the UE 82.

Typically, only policy rules provisioned to the database 704 of the PCRF 700 are used. The data in the SPR 712 are only needed in case some subscriber data shall be used as input combined with the service provider-specific data, in the policy decision.

It is within the comparing unit 706 of the PCRF/PDP 700, 84 that the actions of steps 810 and 1006, comparing obtained address data and provisioned policy rules, is performed, under the control of the control unit 708.

The comparing unit 706 is typically adapted to perform a media stream management control involving the identity address data related to the first electronic communication device and the policy information associated with the second electronic communication device, the first device being represented by the communication server and the second device by the UE 82, according to some embodiments.

The comparison that is being performed by the comparing unit 706 comprises the determination as to whether the obtained address data matches with the provisioned policy rules, as illustrated in step 812, as well as in step 1008, of the PCRF/PDP 700, 84, or not.

The performing the comparison is an example of performing a media stream management control involving the identity address data related to the first electronic communication device, the destination address, and the policy information related to the second electronic communication device being the UE 82.

In the case the comparing unit 706 determines a match between the obtained address data and the provisioned policy rules, which means that there is at least one policy rule associated with the specified address data, the method steps of the PCRF as presented in FIG. 10 continue with the step of obtaining service related quality data for the matched address data, in step 1010. Within this step QoS data of a specific QoS class, as was presented in the table of figure may typically be provided. This step corresponds to the step of obtaining service related quality data for match in step 814, as presented in FIG. 8.

In contrast to the aforementioned step, in case the comparing unit 706 determines that there is no matching between the obtained address data and the provisioned policy rules as determined in steps 812, 1008, the step of obtaining service related quality data for non matched address data follows, as illustrated in step 1012, which step is performed by the PCRF/PDP 706, 84, under control of the control unit 708. As was shown in the table of FIG. 5, a QoS class is here also provided. However, this QoS class may not be specific, rather it is usually provided as a default best effort QoS class irrespective of the requested service application.

According to some embodiments, the comparison as performed in step 810 may also involve the IP Multimedia Subsystem (IMS) Communication Service Identifiers (ICSI). In addition, according to some embodiments, the IMS Application Reference Identifier (IARI) could be used, assuming the SP has provided the operator with the IARI value.

The determination as to whether there is a match or not would thus involve considering the whether the obtained address data as obtained, taken together with the ICSI and the possibly the IARI value, match with the provisioned policy rules, or not.

Having obtained the relevant service related quality data, either in steps 814 and 1010, or in steps 816 and 1012, service related information can be forwarded in signal S-710 as illustrated in FIG. 7 to the transceiving unit 702 of the PCRF 700. The PCRF/PDP may thereafter forward the obtained service related quality data to the PCEF/PEP 714, as illustrated by signal S-716 in FIG. 7, for which the step of forwarding is illustrated by step 1014 in FIG. 10, so that the decided policy can be enforced.

According to this embodiment the PCRF/PDP sends a policy check completion message to the proxy server/AF, as illustrated in step 818 in FIG. 8. This step corresponds to the step sending policy check completion message to proxy server, as illustrated by step 1016 in FIGS. 10 and 820 in FIG. 8.

In FIG. 6, showing an embodiment of an application node as an application function (AF) this policy check completion message is illustrated by S-610 as sent from the PCRF 612 to the transceiving unit 606 of the AF 600, according to this embodiment. This response message is hence sent over the Rx interface between the PCRF 612 and the AF 600.

Sending the policy check completion response from the PCRF/PDP to the proxy server/AF, in steps 818 and 1016, corresponds to the steps of receiving said policy check completion message from the policy decision point (PDP) over the Rx interface, as illustrated by step 908 in FIG. 9.

Within the AF 600 the transceiving unit 606 may send the policy check completion message as signal S-612 to the processing unit 604. The processing unit 604 may then after some processing (not shown) of the signal S-612, send signal S-614 to the SDP port 602, in this example.

The SDP port 602 of the proxy server/AF 600, 86 may thereafter forward the session setup response message, as signal S-616, to the UE 612, 82, as illustrated by step 820 and as shown in FIG. 8

This corresponds to the case in which the step interval I is performed prior to the step interval II, in FIG. 11. For details, see the description in connection with FIG. 11.

According to some alternative embodiments, the SDP port 602 of the proxy-server/AF 600, 86 may forward the session setup request message to the IMS network 614. This corresponds to the case in which the policy check of step interval II is performed prior to the step interval I in FIG. 11.

In FIG. 9 illustrating method step of a proxy server/AF according to an embodiment the step of sending the session setup response message, corresponds to step 910, forwarding session setup response message to the UE 610, 82.

### Service Activation, Session Setup to Service Provider

In the case of a software client in the terminal, a user request will indirectly trigger the setup of an IMS call to a preconfigured or dynamically downloaded destination address.

In the case of a browser in the terminal, the user clicks on a link that is defined to set up an IMS call to a destination address as given by the web page. The browser then triggers an application, for example a browser plug-in, which will initiate this call setup.

The call setup is routed as a SIP INVITE to the P-CSCF in the network, and will include the destination address in the request-URI header. The P-CSCF performs a policy check to the PCRF, and will, together with other service-related information, provide the request-URI to the PCRF.

The operator may perform the QoS policy check at different instances in the SIP signalling sequence. Either, the policy check is triggered when receiving the initial SIP INVITE from the terminal. Or the policy check is triggered when receiving the response from the remote party, including the SDP answer, for instance in SIP 183 Session progress, or SIP 200 OK messages. In the latter case, the P-CSCF ensures that the Request-URI received in the initial SIP INVITE is stored and provided to the policy system at the reception of the response message.

The PCRF uses the provisioned policy rules, and finds a match between the destination address in the request-URI, and the destination address in a specific policy rule. This implies that a higher than normal QoS is decided for the flow(s) of this session, which means higher availability/retain ability/quality for this service.

### Request URI

The Request URI indicates to the IMS network where the request is addressed. The Request URI may be in the form of a SIP Universal Resource Identifier, URI.

According to an embodiment the request URI comprises the Public Service Identifier (PSI) that may be of particular interest. A PSI is a SIP URI or Tel URL identifying a service or specific resource. The service may be a gaming service, a chat service etc. The construction of a PSI is in the form of user@host.domain. The PSI can be totally independent of the address space of the IMS provider.

PSI can be in the form of distinct or wildcard. The distinct PSI is used for routing while wildcard PSI is a regular expression represent a collection of PSI. An example of wildcard PSI is “sip:game!.*!@gameprovider.com”. This expression comprises PSIs such as “sip:gamechess@gameprovider.com”, “sip:gametetris@gameprovider.com”, and “sip:gameracing@gameprovider.com”.

Another possibility to separate PSIs from each other is to use sub domains in the PSI. An example is “sip: chess@beginners.gameprovider.com”, “sip: chess@amatures.gameprovider.com” or chess@pro.gameprovider.com.

In summary, the QoS mechanism is triggered by inspection of the Request URI where the particular case where a PSI is used. The flexibility of PSI-mechanism with either distinct PSI, a PSI that is included in a wild card range or usage of sub domain PSIs bring a powerful tool for enabling QoS tied to a certain Service Provider.

Session Setup Use Cases: Session Setup from Terminal

Various session setup use cases can be outlined in which the session to be setup will originate from the user terminal and terminate in the service provider or alternatively in another user terminal. In other session setup use cases the session setup may originate by the service provider and terminate by the user terminal. The pertinent bearers may also be either network or terminal initiated, as further alternative embodiments of the session setup use case.

In the following a session setup use case from the terminal will be described. As illustrated in FIG. 11, the session setup use case originates at the UE 1102 and terminates at a service provider's application server 1110. In this figure the bearer is network initiated, as will be further described below.

This session setup use case is applicable to IP Multimedia Subsystem (IMS)/Session Initiation Protocol (SIP) signalling, as well to the Real Time Streaming protocol (RTSP), in which the application server 1110 comprises a streaming server.

This session setup use case may start with sending a signal S-1102 from a user client or a browser within the user's terminal (UE) 1102, which signal may be the Hypertext Transport Protocol (HTTP) Get command. This command may for instance comprise a request to download of a webpage from the service provider's application server 1110.

As a response to this request, a signal S-1104 in the form of a HTTP response can then be sent from the service provider's application server 1110 to the client/browser in the UE 1110 according to one embodiment of the session setup use case.

Steps S-1102 and S-1104 are optional within this use case, since these steps may have been performed in beforehand.

After the user subsequently triggers an action, a session setup request message is sent from the terminal 1102 to the proxy server 1108 in the originating network, in step S-1106.

This message may include the address of the service provider's application server as a destination address for the session. For example in the case this message is the SIP INVITE message that is sent to the P-CSCF, the destination address equals the request—URI.

Alternatively, in the case the message is the RTSP SETUP message as sent to the streaming proxy server, the destination address equals the request-URL.

In step S-1108 the Proxy-server extracts the destination address for subsequent usage in the policy control signalling.

The following step in this use case is sending at the session setup request message from the proxy-server in the originating network to the service provider's application server, in step S-1110.

In the IMS case, the message may be transferred via additional IMS nodes, for instance via the Serving-Call Session Control Function (S-CSCF) and optionally the IMS application server(s) in the originating network, in case there are any. If the service provider belongs to another IMS operator, the message may optionally be transferred via one or more IMS transit networks to that IMS network, and via the S-CSCF and optionally IMS applications servers in that IMS network.

The application server may link the incoming session as described here with the earlier user interaction in step S-1102.

The subsequent step is the step of sending the session setup response message in step S-1112 from service provider's application server 1110 to the proxy server 1108 in the originating network. For instance the session setup response message may comprise the RTSP SETUP response, or in the IMS case the SIP 183 Session progress, or alternatively the SIP 200 OK. In the IMS case the response message is communicated via the same path as the session setup request message as in step S-1110.

Thereafter a policy check request message is sent from the proxy-server 1108, for instance the P-CSCF or the streaming server using RTSP, to the policy decision point 1106, for instance the PCRF, over the interface between the two, for instance the Rx interface, in step S-1114.

This policy check request message comprises the session destination address from the step S-1108. The request message may be a message based on the Rx Diameter protocol message AAR, with the addition of the destination address Attribute Value Pair (AVP), which therefore includes the destination address.

In the following step S-1116 the QoS policy evaluation is being performed by the PCRF/PDP 1106.

The PCRF applies the provisioned policy rules on the destination address received over Rx and other information that may be received over the Rx interface, from SPR, or over the Gx interface between the PDP 1106 and the PEP 1104. If the destination address matches an address provisioned for specific QoS handling, for instance from business agreement with the service provider, the outcome is a specific QoS class or alternatively other QoS parameters.

Having decided the policy rules, the step of providing policy and charging control rules to the PCEF/PEP 1104, for instance the GGSN, from the policy decision point (PCRF) 1106 is performed in step S-1118.

This message as sent over the Gx interface includes the definition of service data flow filters, and associated QoS parameters to be enforced for the corresponding data traffic.

The following step of this session setup use case is the resource establishment procedure that may comprise the setup of bearers, which corresponds to step S-1120.

In FIG. 11 it is illustrated that the setup of a bearer between the PCEF/PEP 1104 and the UE 1102, may be initiated by the PCEF/PEP 1104. This bearer setup may therefore be called a network initiated bearer setup.

Having completed the resource establishment, an indication of resources established will be sent from the PCEF/PEP 1104, such as the GGSN, to the PDP/PCRF 1106 in step S-1122.

In connection, in step S-1124, an indication of policy check completed is sent from the PCRF 1106 to the proxy-server 1108. This indication being a response to the policy check request message sent over the Rx interface in step S-1114, may hence be sent back over the Rx interface.

According to an alternative embodiment, the step interval S-1114 to S-1124 may be performed before the step interval S-1110- to S-1112. According to said alternative embodiment the proxy server triggers the policy check to the PDP/PCRF upon extracting the destination address from step S-1108, before proceeding the session setup by forwarding the session setup request message S-1110 towards the service provider's application server.

The subsequent step of this session setup use case is the step of sending the session setup response message in step S-1126 from the proxy server 1108 in the originating network to the user terminal 1102.

The session setup may then continue according to the specific session protocol used. In the case of IMS the UE may for instance, send a SIP ACK, SIP PRACK, SIP INVITE, SIP UPDATE or other message according to SIP specifications. In the case of RTSP an RTSP PLAY or a new RTSP SETUP message may be sent, to mention a few examples only.

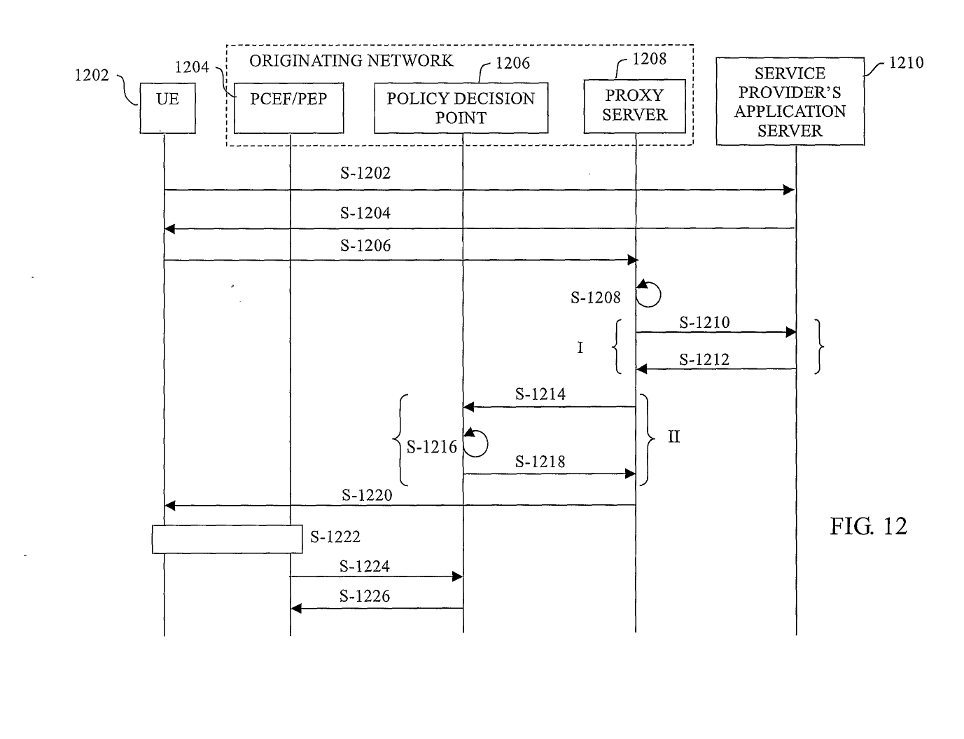

In FIG. 12 a session setup use case, similar to the one as described in connection with FIG. 11, will be described. In the session setup use case in figure the bearer was network initiated. This is in contrast to the bearer initiation as illustrated in FIG. 12, which is terminal initiated, as will be described and illustrated below.

As steps S-1202 to S-1216 are identical to the steps S-1102 to S-1116, as described above, the step interval S-1202 to S-1216 will not be explained in detail, but reference is given to FIG. 11 and the accompanying description.

It is noteworthy that the message as sent in step S-1214, that is the policy check request message from the proxy-server 1208, for instance the P-CSCF or the streaming server using RTSP, to the policy decision point 1206, for instance the PCRF, is sent over the interface between the two, for instance the Rx interface.

It is this policy check request message that may comprise the session destination address from the step S-1208 at which the proxy-server 1208 extracted the destination address.

The policy check request message as sent in step S-1214 may be a message based on the Rx Diameter protocol message AAR, with the addition of the destination address Attribute Value Pair (AVP), which therefore includes the destination address.

As the session setup use case as illustrated in FIG. 12, differs from the one as illustrated in FIG. 11 from step S-1218 and on, these steps will be described in more detail below.

Step S-1218 is the message indication of policy check completed as sent from the PCRF/PDP 1206 to the proxy server 1208, as a response to the policy check request message as sent in step S-1214, which corresponds to step S-1114.

Having received the indication policy check completed in step S-1218 by the proxy server 1208, a session setup response message is sent from the proxy server 1208 to the user equipment 1202, in step S-1220.

Thereafter the step of resource establishment is performed, as step S-1222. If required, in case there is no suitable bearer available, the setup of bearer is also performed. The bearer initiation as is illustrated in FIG. 12 is now initiated by the terminal 1202, in contrast to the initiation as described in FIG. 11 which was network initiated, for instance between the UE 1202 to the PCEF/PEP 1202, that may be in the form of a GGSN.

Subsequently, the step of sending a policy and charging control (PCC) rules request, step S-1224, from the PCEF/PEP 1204, that may be the GGSN, to the PCRF/PDP 1206 is performed.

Thereafter, the PCRF/PDP 1206 provides the policy and charging rules to the PCEF/PEP 1204 for instance the GGSN over the Gx interface, in step S-1226. The Gx message may include definitions of service data flow filters and associated QoS parameters to be enforced for the traffic.

In analogy with the session setup use case as illustrated in FIG. 11, the use case as illustrated in FIG. 12 comprise two step intervals I and II, comprising steps S-1210-S-1212, and S-1214-S-1218, respectively. The step interval II may be executed before the execution of step interval I.

As illustrated in FIGS. 11 and 12, the session setup use cases are relatively similar, as they both originate at the UE 1102 and 1202, respectively and terminate at the service provider's application server 1110 and 1210, respectively.

Additional Use Case: Session Setup from Service Provider

An alternative to including the destination address in the session setup request and thereafter to setup the session, is to setup for instance a SIP session from the Service Provider to the client in the user's terminal. In this case, the QoS should be differentiated based on the originating address of the SIP session, for example the Public Service Identifier (PSI) of the Service Provider's application server. This identifier could be included in the contact-header parameter of the SIP INVITE, for instance.

In non-PSI cases, the P-asserted-identity could be used, in which case a P-asserted Identity header is used among trusted SIP entities to carry the identity of the user sending a SIP message, after have been verified by for example SIM-based authentication.

According to some embodiments the session-originating address may also be forwarded, for example in the form of a header, from the P-CSCF to the PCRF for use in the QoS policy decision.

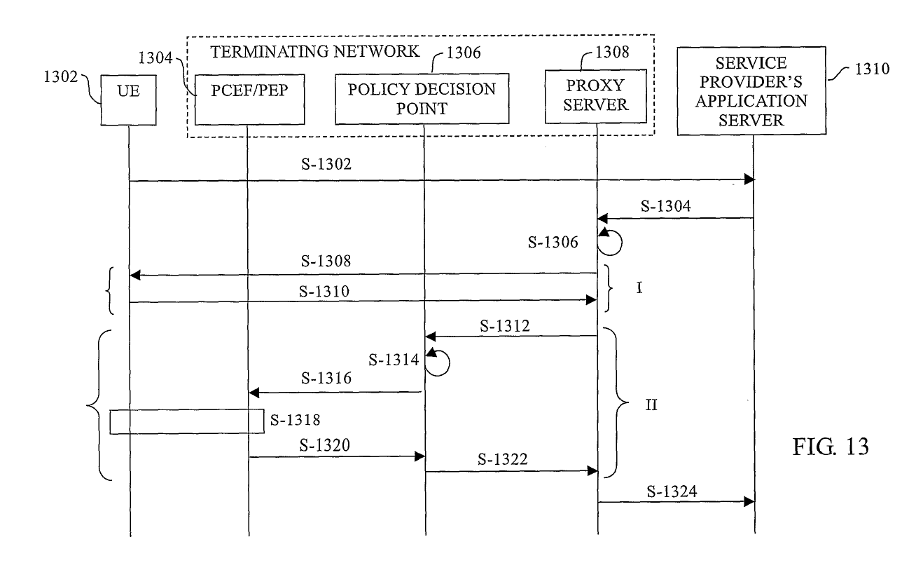

In FIG. 13, a session setup use case from the Service provider's application server is illustrated which session setup use case is applicable to IP Multimedia Subsystem (IMS)/Session Initiation Protocol (SIP) signalling.

This session setup use case starts with step S-1302 sending an application message from the client or browser within user's terminal, UE 1302 to the service provider's application server 1310, in the form of for instance a HTTP Get message, or alternatively another message.

The session setup request message is now sent from the service provider's application server 1310 to the proxy-server 1308 in the terminating, that is the user's network, in step S-1304.

This message may be transferred via additional IMS nodes. It may be transferred via a S-CSCF and optionally IMS application server(s) in the originating network, that is the IMS network of the service provider. In the case the service provider belongs to an IMS operator different from the user, the message may optionally be transferred via one or more IMS transit networks to the user's IMS network, that is terminating network, and via the S-CSCF and optionally IMS Application servers in the users IMS network.

The message as sent includes the address of the service provider's application server as an originating address for the session. For example in the case of a SIP INVITE message sent to the P-CSCF, the originating address can be located in the contact-header, and may in addition or as an alternative be located in the From-header. As yet additional information or an alternative the originating address may be located in the P-asserted-identity header.

Having received the session setup request message in step S-1304, the step of extracting the originating address by the proxy-server 1308 for usage in the subsequent policy control signalling is performed in step S-1306 by the proxy-server 1308.

Then, the session setup request message is sent from the proxy-server 1308 in terminating, that is the user's network to the user's terminal UE 1302, in step S-1308.

In step S-1310, a SIP 183 session progress or SIP 200 OK message may be sent as a session setup response message from the user's terminal UE 1302 to proxy server 1308 in terminating network that equals the user's network in this session setup use case.

From the proxy-server, for instance the P-CSCF 1308 the policy check request message is sent in step S-1312 to the PCRF/PDP 1306. This policy check request message that is sent over the interface between the proxy-server 1308 and the PDP/PCRF 1306, may include the session originating address as extracted by the proxy-server in step S-1306. One example of the message that is based on Rx Diameter protocol message, may be the AAR message with addition of an originating-address Attribute Value Pair (AVP) that includes the originating address.

Having received the policy check request message in step S-1312 by the PDP 1306, said entity performs a QoS policy evaluation, in step S-1314. Here the PCRF applies the provisioned policy rules on the originating address received over the Rx interface and other information that may be received from the Rx interface, from the SPR or from the Gx. If the originating address matches an address that is provisioned for specific QoS handling, for example from business agreement with the service provider, the outcome may be a specific QoS class or alternatively other QoS parameters.

The next step is thus the step of providing the decided policy and charging control rule to the PCEF/PEP 1304 from the policy decision point/PCRF 1306, in step S-1316. The Gx message sent to the PCEF/PEP that may be exemplified as the GGSN may include the definitions of service data flow filters, and associated QoS parameters to be enforced for the corresponding traffic.

Now the resources are established in the procedure of step S-1318. This procedure may also include the setup of a bearer from the PCEF/PEP 1304 to the S-1302 in case there is no suitable bearer available. It should be noted that this resource establishment might be initiated from the network or rather the GGSN, as one example of the PCEF/PEP 1304.

The subsequent step, step S-1320 is to send an indication of resources established from the PCEF/PEP 1304, as for example the GGSN, to the PDP/PCRF 1306.

This step is followed by performing step S-1322, sending an indication of policy check completed from the PCRF 1306 to the proxy-server 1308 in the terminating network over the interface that connects the PDP/PCRF 1306 to the proxy-server 1308. One example of this interface is the Rx interface.

Now, the session setup response message can be sent from proxy server 1308 in terminating, that is the user's network to the service provider's application server 1310 in the originating network, in step S-1324. This message is sent via the same IMS nodes as the session setup request messages as was sent in step S-1304.

In analogy with the case for the session setup use cases in FIGS. 11 and 12, the step interval II comprising steps S-1312-S-1322 may be performed before the step interval I comprising steps S-1308 and S-1310, according to some embodiments.

### Yet Another Use Case: Person to Person Communication Session Setup Use Case

Let the subscriber provide a set of addresses, to and from which the operator will ensure differentiated QoS treatment. This has similarities with subscription offerings from some operators today, such as call for free or low tariff to a selected number of friends.

According to some embodiments both the originating and destination addresses are provided to the policy system, so that only certain combinations are upgraded in terms of quality/availability. Thus both the Request-URI and the P-asserted-identity or as an alternative the contact-header, should be forwarded on Rx.

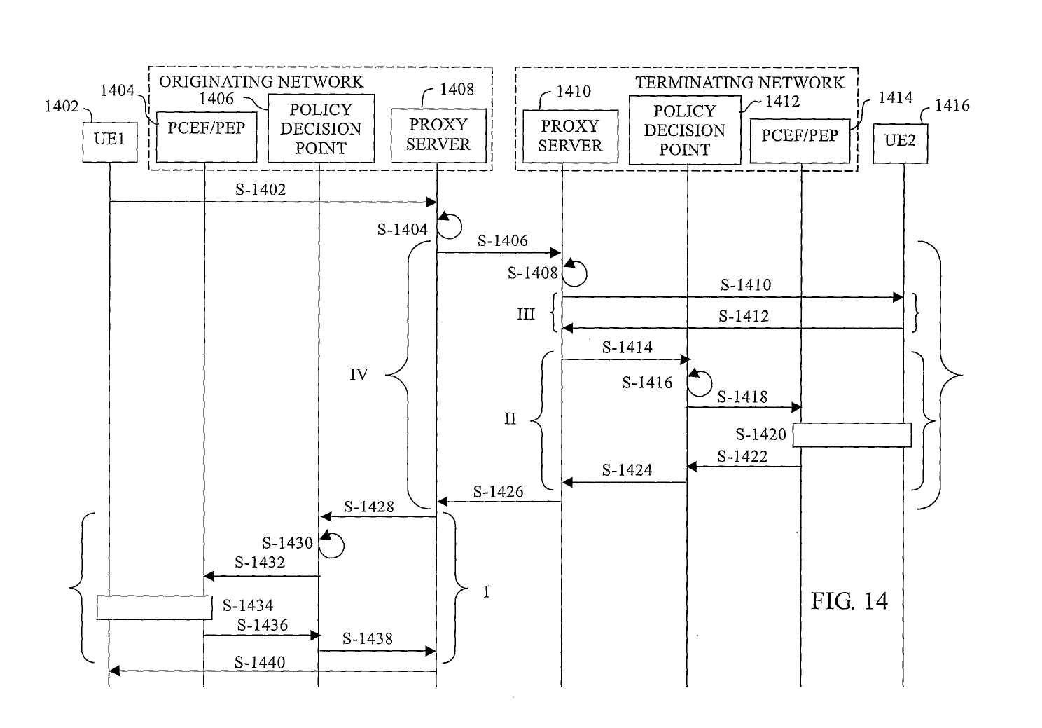

In FIG. 14 a session setup use case from a first user UE1 1402 to a second user UE2 1416 is illustrated. This session setup signalling is applicable to the IMS/SIP signalling.

This use case starts with the UE1 1402 sending a session setup request message to the proxy-server 1408 in the network of the UE1 1402, that is the originating network, in step S-1402. This is a consequence of a user's triggering of an action on the terminal UE1 1402, to communicate with a friend, the user of UE2 1416.

The session setup request message may include the address (URI) of the friend as a destination address for the session. For instance in the case of a SIP INVITE message as sent to the P-CSCF 1408, the destination address equals the request-Uniform Resource Identifier (URI).

In step S-1404 the proxy-server 1408 of the originating network extracts the destination address for subsequent usage in the policy control signalling. In addition, said proxy-server 1408 also extracts an originating address, that is the address of the originating user. This address may be verified after authentication and may be signalled onwards in the P-asserted-identity.

From the proxy-server 1408 in originating network to the terminating proxy server 1410, that is the proxy-server in the terminating network, the session setup request message is forwarded in step S-1406.

This request message may be sent via a Serving-Call Session Control Function (S-CSCF) and optionally via IMS application servers in originating network, and optional IMS transit network(s), the S-CSCF and further optionally IMS application servers in the destination network.

After having received the request message the proxy-server 1410 in the terminating network extracts the originating and destination addresses in step S-1408, for subsequent usage in the policy control signalling.

The session setup request message is then forwarded from the proxy-server 1410 in terminating network to the user's terminal, UE2 1416, in step S-1410.

From the user's terminal, UE2 1416 a session setup response message may thereafter be sent in step S-1412 to the proxy-server 1410 in the terminating network. This response message may for instance comprise the SIP 183 Session Progress or the SIP 200 OK message.

Now, the terminating proxy-server 1410, for example a P-CSCF sends a policy check request message to policy decision point 1412, for instance the PCRF 1412, in step S-1414. This policy check request message typically includes the session originating and destination addresses as extracted in step S-1408.

For example this message may constitute a message based on the Rx Diameter protocol message AAR with addition of a destination-address AVP, which includes the destination address, and an originating-address AVP, including the originating address.

Now, the PCRF 1412 may perform the QoS policy evaluation in step S-1416, where the PCRF applies the provisioned policy rules on the combination of the destination and originating addresses received over the Rx interface and other information, for example from the Rx interface, from the SPR, and from the Gx interface. If the address combination matches an address combination provisioned for specific QoS handling, for example from subscription agreement with the originating user, the outcome may be a specific QoS class or alternatively other QoS parameters.

In the following step, step S-1418 the policy and charging control rules are provided to the PCEF/PEP 1414, such as the GGSN, from the policy decision point/PCRF 1412. As mentioned in connection to other session setup use cases the Gx message may include definitions of service data flow filters, and associated QoS parameters to be enforced for the corresponding traffic.

Now, the procedure to establish resources is executed in step S-1420. Also, if required the setup of a bearer is performed. As illustrated in FIG. 14, the setup is initiated from the PCEF/PEP 1414 towards the UE2 1416, which means that the setup is initiated from the network part, especially the GGSN to the UE2 1416.

From the PCEF/PEP 1414, that is the GGSN, an indication of resources established is then sent to the PCRF 1412, in step S-1422.

Thereafter an indication of policy check completed may be sent from the PCRF 1412 to the proxy-server 1410 in the terminating network, in step S-1424.

It shall be noted that the steps comprising the policy check in the terminating network, that is steps S-1414 to S-1424, as denoted by II in FIG. 14, may be executed before the steps of sending the session setup request message S-1410 from the proxy-server 1410 in the terminating network to the UE2 1416, and receiving the session setup response message S-1412 by the proxy-server 1410 in the terminating network from the UE2 1416, that is the step interval as denoted by III in FIG. 14.

Moreover, the step interval I, that is steps S-1428 to step S-1438 may be executed prior to executing the step interval IV, comprising steps S-1406 to S-1426, according to some alternative embodiments.

Subsequently, the session setup response message is sent from the proxy server 1410 in the terminating network to the proxy server 1408 in the originating network, in step S-1426, via the same IMS nodes as the corresponding session setup request message, as sent in step S-1406.

Having received the session setup response message by the proxy-server 1408 in the originating network, a policy check request message may be sent in step S-1428, from the proxy-server 1408, for example the P-CSCF 1408 to the policy decision point/PCRF 1406 in the originating network. This policy check request message typically includes the session destination and originating addresses that were extracted in step S-1404.

For example, this message may be a message based on Rx Diameter protocol message AAR with addition of a destination-address AVP, which includes the destination address, and an originating-address AVP, including the originating address.

In the step S-1430 a QoS policy evaluation is now performed by the PDP/PCRF 1406, whereby the PCRF applies the provisioned policy rules on the combination of the destination and originating addresses that were received over the Rx interface and other information as received over the Rx interface, from the SPR, or over the Gx interface. If the address combination matches an address combination provisioned for specific QoS handling, for instance from subscription agreement with the originating user, the outcome is a specific QoS class or alternatively other QoS parameters.

The policy decision point/PCRF 1406 now provides the policy and charging control rules to the PCEF/PEP 1404 in step S-1432, where the PCEF/PEP may be the GGSN. Again, the Gx message as sent might include definitions of service data flow filters, and associated QoS parameters to be enforced for the corresponding traffic.

In the next step, step S-1434 resources are established between the PCEF/PEP 1404 and the UE1 1402. In case there is no suitable bearer available this step may also comprise the setup of a bearer. The setup is here initiated from the network as illustrated in FIG. 14.

Having accomplished the resource establishment, an indication of resources established might be sent from the PCEF/PEP 1404, or rather the GGSN, in step S-1436 to the PCRF/PDP 1406.

Subsequently, the PCRF/PDP 1406 may forward an indication of policy check completed in step S-1438 to the proxy-server 1408 of the current network that is the originating network.

The next step of the session setup use case between two users, is to send a session setup response message in step S-1440 from proxy server 1408 in originating network to the originating terminal, UE1 1402.

From now on, the session setup can continue as normally.

A sub-alternative to providing the destination address in the form of a request-URI from P-CSCF to PCRF, would be to provide it from an application server within the same operators network to the PCRF, over a new interface. This has the advantage that, in case addressing is done with E.164 numbers, the application server has performed a destination address analysis, and converted the request-URI into a well-defined format. This may ensure that the format of the address provided by the end-user making the call, is for instance the international format.

According to some alternative embodiments the IMS operator itself acts as the service provider.

It is emphasized that the present invention can be varied in many ways, of which the alternative embodiments as presented are just a few examples. These different embodiments are hence non-limiting examples. The scope of the present invention, however, is only limited by the subsequently following claims.

Besides QoS control differentiation, the enhancement of the information as forwarded over the Rx interface can also be used by the PCRF to increase the granularity of other PCRF functions like charging control, according to some embodiments.

According to some embodiments, the exact order of the steps of the methods related to providing call service for a call can be changed and some steps can even be deleted without deferring from the scope of protection of the present invention.

It is thus easy to understand that some embodiments come with a number of advantages of which a few are:

A deeper and flexible control is allowed in the process of identifying the traffic to apply policy control, as well as in the policy control itself, following at least some of the embodiments.

The application of a unified policy control above the IP transport level is permitted.

In addition, usage of new parameters to perform dynamic packet classification, for instance Uniform Resource Locators (URLs) and policy control, are enabled.

At least some embodiments enable an IMS operator to differentiate the QoS for data flows to or from a selected third party service provider.

According to at least some embodiments a service provider is enabled to request, from an IMS operator, that its services should be delivered with certain quality, for instance premium quality.

1. A method for providing management control attribute data for media stream management control of a service session between a first electronic communication device and a second electronic communication device, said method comprising the steps of:
receiving a service session related,
obtaining identity address data related to the first electronic communication device, and
sending an attribute related policy request message associated with the service session request to a policy decision node, said message comprising the obtained identity address data related to the first electronic communication device, such that the message can be processed by the policy decision node.

2. The method for providing management control attribute data according to claim 1, further comprising the step of receiving an attribute related policy response message associated with the requested service session, from the policy decision node.

3. The method for providing management control attribute data according to claim 1, wherein the step of obtaining identity address data further comprises obtaining identity address data related to the second electronic communication device, and wherein the attribute related policy request message further comprises the obtained identity address data related to the second electronic communication device.

4. The method for providing management control attribute data according to claim 1, wherein the step of obtaining identity address data comprises obtaining public service identity address data.

5. An application node for providing management control attribute data for media stream management control of a service session between a first electronic communication device and a second electronic communication device, said application node comprising:
a receiving unit adapted to receive a service session related request,
a processing unit adapted to obtain identity address data related to the first electronic communication device, and
a transceiving unit adapted to send an attribute related policy request message associated with the service session request.

6. The application node according to claim 5, wherein the transceiving unit further is adapted to receive an attribute related policy response message associated with the requested service session.

7. A method for processing of management control attribute data for media stream management control of a service session between a first electronic communication device and a second electronic communication device, said method comprising the steps of:
receiving an attribute related policy request message associated with the service session request, from an application node, said message comprising identity address data related to the first electronic communication device;
obtaining policy information associated with the second electronic communication device, and
performing a media stream management control involving the identity address data related to the first electronic communication device and the policy information related to the second electronic communication device.

8. The method for processing of management control attribute data according to claim 7, further comprising the step of sending an attribute related policy response message associated with the requested service session, to the application node, to enable provision of the requested service session between the first and second electronic communication devices, in dependence of the performed media stream management control.

9. The method for processing of management control attribute data according to claim 7, wherein the step of receiving the attribute related policy request message further comprises receiving an attribute related policy request message comprises identity address data related to the second electronic communication device, and wherein the step of performing the media stream management control further comprises performing said media stream management control involving the identity address data related to the second electronic communication device.

10. The method for processing of management control attribute data according to claim 7, wherein the service session between the first electronic communication device and the second electronic communication device is set up from the first electronic communication device to the second electronic communication device.

11. The method for processing of management control attribute data according to claim 7, wherein the service session between the first electronic communication device and the second electronic communication device is set up from the second electronic communication device to the first electronic communication device.

12. The method for processing of management control attribute data according to claim 7, wherein the step of performing a media stream management control comprises performing a control of the quality of service class for a flow of packets of the media stream.

13. The method for processing of management control attribute data according to claim 7, wherein the step of performing a media stream management control comprises performing a control of charging parameters for a flow of packets of the media stream.

14. A policy decision node adapted to process management control attribute data for media stream management control of a service session between a first and a second electronic communication device, said policy node comprising:
a transceiving unit adapted to receive an attribute related policy request message associated with a service session request, said policy request message comprising identity address data related to the first electronic communication device;
a storing unit adapted to obtain policy information associated with the second electronic communication device, and
a comparing unit adapted to perform a media stream management control involving the identity address data related to the first electronic communication device and the policy information associated with the second electronic communication device.

15. The policy decision node according to claim 14, wherein the transceiving unit further is adapted to send an attribute related policy response message associated with the requested service to enable provision of the service session between the first and second electronic communication devices, in dependence of the performed media stream management control.

16. A method for media stream management of a service session between a first electronic communication device and a second electronic communication device, said method comprising:
obtaining identity address data related to the first electronic communication device,
obtaining policy information associated with the second electronic communication device, and
performing a media stream management control involving the identity address data related to the first electronic communication device and the policy information related to the second electronic communication device such that media streams between the first electronic communication device and the second electronic communication device can be controlled.

17. A system for performing media stream management of a session between a first electronic communication device and a second electronic communication device, said system comprising:
a processing unit adapted to obtain identity address data related to the first electronic communication device,
a storing unit adapted to obtain policy information associated with the second electronic communication device, and
a comparing unit adapted to perform the media stream management control involving the identity address data related to the first electronic communication device and the policy information associated with the second electronic communication device,
enabling media stream management control of session between the first electronic communication device and the second electronic communication device.
